(19) United States
(12) Patent Application Publication
(10) Pub. No.: US 2020/0269512 A1
(43) Pub. Date: Aug. 27, 2020

(54) GAS SUPPLY CONTROL FOR CONDITIONING PARTICULATE MATERIAL

(71) Applicant: HEWLETT-PACKARD DEVELOPMENT COMPANY, L.P., Spring, TX (US)

(72) Inventors: Terry Lambright, Corvallis, OR (US); David R. Otis, JR., Corvallis, OR (US)

(21) Appl. No.: 16/608,852

(22) PCT Filed: Oct. 20, 2017
(86) PCT No.: PCT/US2017/057718

§ 371 Date: Oct. 27, 2019

(51) Int. Cl. B29C 64/393; B29C 64/321; B29C 64/153; B33Y 10/00; B33Y 30/00; B33Y 50/02

(52) U.S. Cl. CPC B29C 64/393; B29C 64/321; B33Y 50/02; B33Y 10/00; B33Y 30/00; B29C 64/153

(57) ABSTRACT

According to examples, an apparatus may include a controller to identify a property of particulate material contained in a container and to determine, based upon the identified property of the particulate material, a parameter of a supply of gas fed into a conditioning assembly to condition the particulate material contained in the container. The controller may further control a mechanism to supply the gas at the determined parameter into the conditioning assembly.

### BACKGROUND

In three-dimensional (3D) printing, an additive printing process is often used to make three-dimensional solid parts from a digital model. 3D printing is often used in rapid product prototyping, mold generation, mold master generation, and short-run manufacturing. Some 3D printing techniques are considered additive processes because they involve the application of successive layers of particulate material to an existing surface (template or previous layer). Additive processes often include solidification of the particulate material, which for some materials may be accomplished through use of heat and/or chemical binders.

### BRIEF DESCRIPTION OF THE DRAWINGS

Features of the present disclosure are illustrated by way of example and not limited in the following figure(s), in which like numerals indicate like elements, in which:

FIG. 1 shows a block diagram an example computing apparatus that may control a mechanism to supply gas to particulate material to condition the particulate material via a conditioning assembly;

FIG. 2 shows a block diagram of an example system for conditioning particulate material via a conditioning assembly;

FIG. 3 shows a perspective view of an example apparatus that includes components to condition a particulate material;

FIG. 4 shows a diagram of a section of an example porous membrane of a conditioning assembly formed of an open cell foam;

FIG. 5 shows a schematic diagram of another example apparatus;

FIG. 6 shows a perspective, exploded view of an example conditioning assembly;

FIG. 7 shows a flow diagram of an example method for controlling a gas supply mechanism to supply gas at a determined parameter into a conditioning perspective view of an example conditioning assembly; and

FIG. 8 shows a block diagram of an example 3D printing system in which the apparatuses and conditioning assemblies disclosed herein may be implemented.

### DETAILED DESCRIPTION

Disclosed herein are computing apparatuses to control a parameter of a gas supplied to condition particulate material contained in a container or equivalently, a hopper, via a conditioning assembly. The computing apparatuses disclosed herein may each include a controller that may identify a property of the particulate material. The property of the particulate material may be a physical property of the particulate material such as the type of materials from which the particulate material is formed, the amount of particulate material contained in the container, a combination thereof, or the like. The controller may also determine a parameter of a supply of a gas fed into a conditioning assembly based upon the identified property of the particulate material. The parameter of the supply of gas may include, for instance, a volume flow rate at which the gas is supplied, a temperature of the gas being supplied, a moisture content of the gas being supplied, combinations thereof, or the like. By way of example, the controller may determine the volume flow rate at which the gas is to be fed to condition the particulate material based upon the identified property. The controller may further control the gas supply mechanism to supply gas at the determined parameter.

Through implementation of the apparatuses and methods disclosed herein, particulate material, such as build material particles for use in 3D printing operations may be conditioned based upon a property of the particulate material. In this regard, the conditioning of the particulate material may be tailored to the property of the particulate material and thus, the particulate material may more accurately be conditioned. That is, for instance, the particulate material may reach a predefined level of fluidization, a predefined level of moisture content, a predefined temperature level, combinations thereof, or the like.

Before continuing, it is noted that as used herein, the terms “includes” and “including” mean, but is not limited to, “includes” or “including” and “includes at least” or “including at least.” The term “based on” means “based on” and “based at least in part on.”

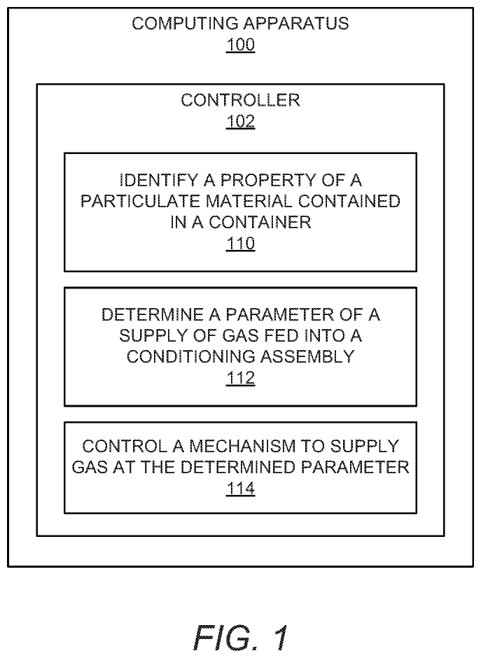

With reference first to FIG. 1, there is shown a block diagram of an example computing apparatus 100 that may control a mechanism to supply gas to particulate material to condition the particulate material via a conditioning assembly. It should be understood that the apparatus 100 depicted in FIG. 1 may include additional components and that some of the components described herein may be removed and/or modified without departing from a scope of the apparatus 100 disclosed herein.

The computing apparatus 100 may include a controller 102 that may perform various functions of the computing apparatus 100. As shown in FIG. 1, the controller 102 may identify 110 a property of a particulate material contained in a container, which may also be referenced herein as a hopper. In various examples, the particulate material may be build material particles used to form 3D objects through a 3D printing operation. For instance, the particulate material may be formed of any suitable material including, but not limited to, polymers, plastics, metals, and ceramics and may be in the form of a powder or a powder-like material. Additionally, the particulate material may be formed to have dimensions, e.g., widths, diameters, or the like, that are generally between about 5 μm and about 100 μm. In other examples, the particulate material may have dimensions that are generally between about 30 μm and about 60 μm. The particulate material may have any of multiple shapes, for instance, as a result of larger particles being ground into smaller particles. In addition, the particulate material 316 may be fresh powder (e.g., unused build material particles), used powder (e.g., recycled build material particles), or a combination of fresh and used powder. The terms “particulate material” and “build material particles” may be used interchangeably herein. In some examples, the powder may be formed from, or may include, short fibers that may, for example, have been cut into short lengths from long strands or threads of material.

The property of the particulate material may include, for instance, the amount of particulate material contained in the container, the level that the particulate material contained in the container reaches, the type of particulate material, or the like. As discussed herein, the level that the particulate material reaches in the container may be identified or calculated from a measured weight of the particulate material contained in the container. In addition or in other examples, the level of the particulate material in the container may be identified from a detected pressure inside of a conditioning assembly. The level of the particulate material may additionally or in other examples be detected through use of another type of sensor, such as an optical sensor. The type of the particulate material may include whether the particulate material is formed of polymers, metals, ceramics or the like. The type of the particulate material may be determined through access of information pertaining to the particulate material, for instance, through electronic information retrieval from a chip, through receipt of user inputted information, or the like.

The controller 102 may determine 112 a parameter of a supply of gas fed into a conditioning assembly to condition the particulate material contained in the container. The parameter of the supply of gas may include gas type, gas supply velocity, gas supply volume flow rate, gas supply temperature, gas supply moisture content, combinations thereof, or the like.

The controller 102 may further control 114 a gas supply mechanism to supply the gas at the determined parameter into the conditioning assembly. The gas supply mechanism may be a mechanism that may control a parameter of the gas that is supplied into the conditioning assembly. That is, for instance, the gas supply mechanism may be a controllable pump, a controllable blower, or the like, and the gas supply mechanism may be controlled to vary the volume flow rate at which gas is supplied into the conditioning assembly. As another example, the gas supply mechanism may fluidically be connected to a plurality of gas type sources and the gas supply mechanism may be controlled to vary the source from which the gas is supplied into the conditioning assembly. As a further example, the gas supply mechanism may include a heater and/or a chiller and may be controlled to vary the temperature of the gas supplied into the conditioning assembly. As a yet further example, the gas supply mechanism may include a humidifier and/or a dehumidifier and the gas supply mechanism may be controlled to vary the moisture content of the gas, e.g., the humidity level of the gas.

By way of particular example, the controller 102 may identify that the particulate material includes a metallic material and may be prone to oxidization. In this example, the controller 102 may determine that a parameter of the gas fed into the conditioning assembly is an inert gas such as nitrogen. As another example, the controller 102 may identify that the particulate material is to be maintained at a particular moisture level to prevent, for instance, static charge buildup among the particles of the particulate material. In this example, the controller 102 may determine that a parameter of the gas fed into the conditioning assembly is to be at the particular moisture level.

The computing apparatus 100 may be a computer, a control circuit, or the like. In examples in which the computing apparatus 100 is a control circuit, the controller 102 may be a circuit component. In examples in which the computing apparatus 100 is a computer, the controller 102 may be a semiconductor-based microprocessor, a central processing unit (CPU), an application specific integrated circuit (ASIC), a field-programmable gate array (FPGA), a graphics processing unit (GPU), a tensor processing unit (TPU), and/or other hardware device.

In addition, the computing apparatus 100 may include a memory that may have stored thereon machine readable instructions (which may also be termed computer readable instructions) that the controller 102 may execute. The memory may be an electronic, magnetic, optical, or other physical storage device that contains or stores executable instructions. The memory may be, for example, Random Access memory (RAM), an Electrically Erasable Programmable Read-Only Memory (EEPROM), a storage device, an optical disc, and the like. The memory, which may also be referred to as a computer readable storage medium, may be a non-transitory machine-readable storage medium, where the term “non-transitory” does not encompass transitory propagating signals.

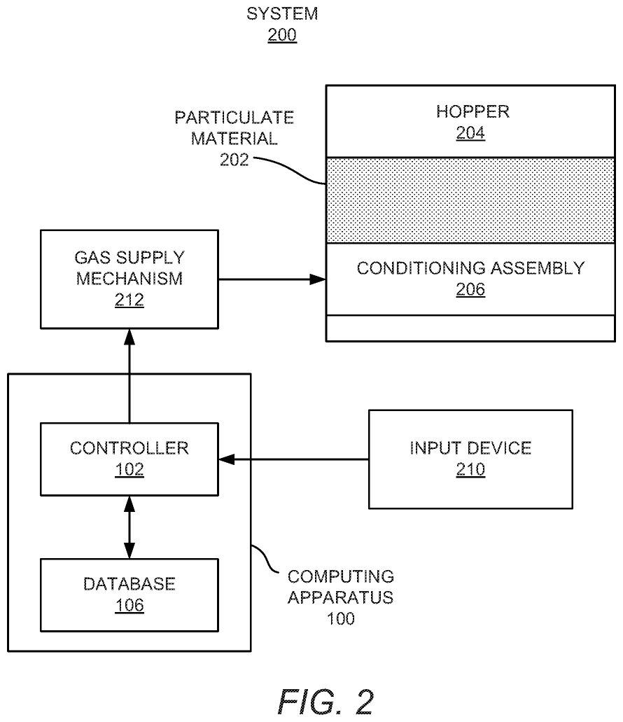

Turning now to FIG. 2, there is shown a block diagram of an example system for conditioning particulate material 202 via a conditioning assembly 206. The system 200 may include the computing apparatus 100 and the controller 102 discussed above with respect to FIG. 1. The system 200 may also include a hopper 204 in which the particulate material 202 may be provided. For instance, the particulate material 202 may be provided into the hopper 204 from a supply container, from a build bucket of a 3D printing system, or the like.

The system 200 may further include a conditioning assembly 206 that may be included within the hopper 204 and/or may form part of the hopper 204. Generally speaking, the conditioning assembly 206 may include a porous membrane through which gas may permeate and be supplied into the particulate material 202. The flow of the gas through the particulate material 202 may fluidize a portion or all of the particulate material 202 in the hopper 202 and may also condition the particulate material 202. That is, the flow of gas through the particulate material 202 may cause the particulate material 202 to acquire characteristics of a fluid. Various examples of the conditioning assembly 206 are described in detail herein.

The system 200 may further include an input device 210 that may input information to the controller 102. The input device 210 may be a sensor, such as a weight, relative humidity, level, pressure, or the like, sensor, to detect a feature of the particulate material 202. For instance, the input device 210 may be a weight scale to detect the weight of the particulate material 202 in the hopper 204. That is, the input device 210 may be provided beneath the hopper 204 and may detect the weight of the hopper 204 and the particulate material 202. The weight of the hopper 204 may be removed from the measured weight to determine the weight of the particulate material 202. In another example, the input device 210 may be a pressure sensor positioned to detect a pressure level inside a space between a porous membrane and a bed. The pressure level may vary depending upon the amount of particulate material 202, e.g., the pressure level may be higher when there is a larger amount of particulate material 202 in the hopper 204 as the particulate material 202 may impede the flow of gas, for instance, per Darcy's Law.

As another example, the input device 210 may be a scanner or other device that may communicate with an electronic tag associated with the particulate material 202 to access an identification of the type of the particulate material 202. That is, for instance, the particulate material 202 may be supplied from a bin (not shown) and the electronic tag may be provided on the bin, which the input device 210 may read to identify the type of the particulate material 202. By way of example, the input device 210 may read a serial number corresponding to the particulate material 202 contained in the bin and may identify the particulate material type from the serial number.

As a further example, the input device 210 may be a user input device through which a user may input the type of the particulate material 202 to the controller 102. In this example, the controller 102 may receive the particulate material 102 type from the user input.

In any of the above-described examples, the controller 102 may process the received information to determine how a gas supply mechanism 212 is to be operated. That is, for instance, the controller 102 may access a database 106 that specifies correlations between various inputted information and operations of the gas supply mechanism 212. In other words, the database may include data that correlates a plurality of particulate material properties and gas supply parameters. By way of example, the database 106 may specify for a particular particulate material 202 weight, that the gas supply mechanism 212 is to supply gas at a particular volume flow rate. As another example, the database 106 may specify that for a particular type of particulate material 202, the gas supply mechanism 212 is to supply a particular type of gas, e.g., nitrogen. The correlations between the particulate material properties and the gas supply parameters may be determined through testing and the results of the testing may be stored in the database 106.

The gas supply mechanism 212 may be a mechanism to controllably supply gas into the conditioning assembly 206. For instance, the gas supply mechanism 212 may control the volume flow rate at which gas is supplied into the conditioning assembly 206. In this example, the gas supply mechanism 212 may be a pump, a blower, or the like and the controller 102 may control the gas supply mechanism 212 to vary the volume flow rate of the supply of gas into the conditioning assembly 206. In addition or in another example, the gas supply mechanism 212 may control the type of gas supplied into the conditioning assembly 206, e.g., air, nitrogen, argon, or the like. In this example, the gas supply mechanism 212 may have access to supplies of various types of gases and may control from which of the supplies gas is supplied into the conditioning assembly 206. In addition, or as a further example, the gas supply mechanism 212 may vary a temperature of the gas supplied into the conditioning assembly 206. In this example, the gas supply mechanism 212 may be a heater and/or a chiller. In addition, or as a yet further example, the gas supply mechanism 212 may vary a moisture content of the gas supplied into the conditioning assembly 206. In this example, the gas supply mechanism 212 may be a humidifier and/or a dehumidifier.

According to examples, the gas supply mechanism 212 may control multiple characteristics of the gas supplied into the conditioning assembly 206. That is, for instance, the controller 102 may control the gas supply mechanism 212 to supply a particular type of gas at a particular temperature into the conditioning assembly 206. As another example, the controller 102 may control the gas supply mechanism 212 to supply a particular type of gas from a plurality of gas types, at a particular temperature, and at a particular volume flow rate.

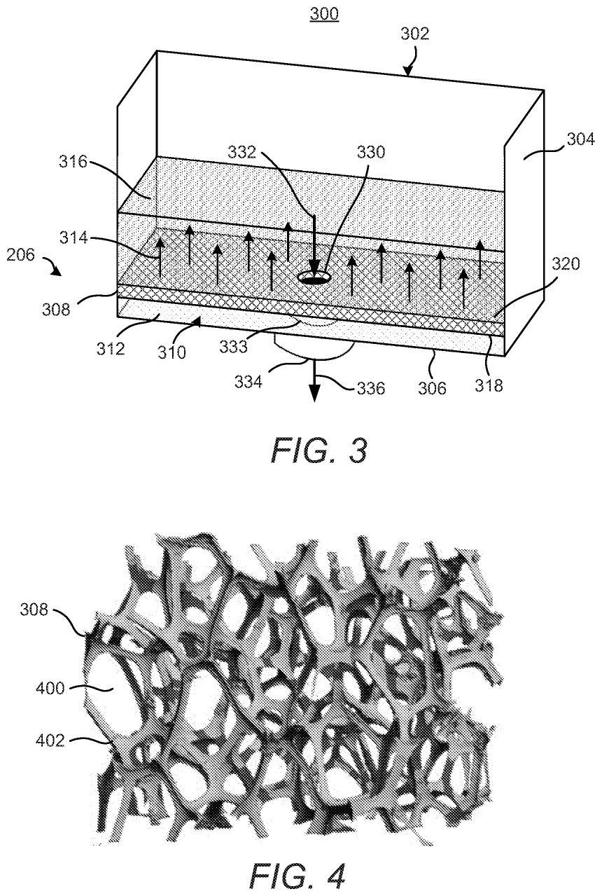

With reference now to FIG. 3, there is shown a perspective view of an example apparatus 300 that includes components to condition a particulate material, which may include fluidizing the particulate material. It should be understood that the apparatus 300 depicted in FIG. 3 may include additional components and that some of the components described herein may be removed and/or modified without departing from a scope of the apparatus 300 disclosed herein.

As shown in FIG. 3, the apparatus 300 may include the conditioning assembly 206 discussed above. The conditioning assembly 206 may be housed in a hopper 302 (which may equivalently be termed a container). The hopper 302 may have sidewalls 304 and a bed 306 positioned within the side walls 304. One of the walls 304 has been removed to better illustrate the interior of the hopper 302. The apparatus 300 may also include a porous membrane 308 supported above the bed 306 such that a space 310 may exist between the bed 306 and the porous membrane 308. The bed 306 may be a floor of the hopper 302 or may be a component that rests on a floor of the hopper 302. As discussed herein, the space 310 may be pressurized with a gas 312 and the gas 312 may flow through the porous membrane 308 as indicated by the arrows 314. In addition, the gas 312 may permeate into the particulate material 316 that is supported on the porous membrane 308. The conditioning assembly 206 may include the bed 306 and the porous membrane 308.

In examples, the gas supply mechanism 212 may supply the gas 312 into the space 310 through a gas delivery opening (not shown) in the bed 306 with sufficient pressurization to cause the gas 312 to flow through the porous membrane 308 with sufficient velocity and pressure to fluidize the particulate material 316. That is, the gas 312 may be supplied at sufficient velocity into the space such that the gas permeating through the particulate material 316 causes the particulate material 316 to acquire characteristics of a fluid, which may mix the particulate material 316 and may facilitate movement of the particulate material 316. In addition, the gas supply mechanism 212 may supply the gas 312 into the space 310 to have various parameters as discussed herein. Fluidization of the particulate material 316 may also help with the outflow of the particulate material 316 from the hopper 302 by enabling the particulate material 316 to flow better and to self-level. Self-leveling of the particulate material 316 may also aid in the accurate detection of the features of the particulate material 316, e.g., a load cell signal may be more reliable as the center of gravity of the particulate material 316 may be centered with the center of the hopper 302 may be centered.

The porous membrane 308 may extend across opposite side walls 304 to prevent the particulate material 316 from falling between the porous membrane 308 and the sidewalls 304 and into the space 310. In addition, the porous membrane 308 may be formed of a material and may have a suitable thickness to support the particulate material 316. For instance, the porous membrane 308 may be formed of polyethylene, metal, plastic, combinations thereof, or the like. By way of particular example, the porous membrane is formed of ultra high molecular weight polyethylene (UHMWPE). The thickness of the porous membrane 308 may be selected based upon the type and/or the amount of particulate material 316 that the hopper 302 is to house.

The porous membrane 308 may have a plurality of pores (which are equivalently termed channels herein), that enable the gas 312 to flow from a first side 318 of the porous membrane 308 facing the bed 306 to a second side 320 of the porous membrane 308 that faces away from the bed 306. The pores (channels) may follow tortuous or equivalently, circuitous, paths from the first side 318 to the second side 320 of the porous membrane 308. That is, for instance, the pores may not follow a direct vertical path from the first side 318 to the second side 320 of the porous membrane 308. In some examples, the porous membrane 308 may be formed by bonding beads of material together with an adhesive or through partially melting of the beads, which may have spherical shapes. As another example, the porous membrane 308 may be formed of an open cell foam as shown in FIG. 4. That is, the porous membrane 308 may include a plurality of pores 400 formed between a material forming a mesh or interlaced structure.

According to examples, the pores 400 may have sizes that are sufficiently small to thus prevent the particulate material 316 from entering and/or blocking the pores 400. In addition or in other examples, the pores 400 may have sizes that are between about 5 microns and about 20 microns and include a density of about 10 and about 50 percent of a material forming the porous membrane 308. In other examples, the pores 400 may have sizes that are about 10 microns and may include a density of about 30 percent of the material forming the porous membrane 308. For instance, the pores 400 may have sizes that are between and including 9 microns and 11 microns and may include a density of between and including 29 and 31 percent of the material forming the porous membrane 308. In still other examples, the pores 400 may have sizes that are 10 microns and/or may include a density of 30 percent of the material forming the porous membrane 308.

With reference back to FIG. 3, the porous membrane 308 may include a drain opening 330. In some examples, the drain opening 330 may include a cutout portion of the porous membrane 308. In addition or in other examples, the drain opening 330 may include a drain member around a cutout portion, in which the drain member may be a metal or plastic member that defines the drain opening 330. In any regard, the particulate material 316 may flow through the drain opening 330 (as represented by the arrow 332) to be delivered out of the hopper 302. That is, some of the particulate material 316 may flow through the drain opening 330, through a drain aperture 333 formed in the bed 306, and into a controllable feeder 334. The controllable feeder 334 may control the expulsion of the particulate material 316 from the hopper 302 as indicated by the arrow 336. The controllable feeder 334 may be positioned beneath the bed 306 and particulate material 316 that has flowed through the drain opening 330 and the drain aperture 333 may be supplied into the controllable feeder 334 and the controllable feeder 334 may control the expulsion of the particulate material 316 (as represented by the arrow 336).

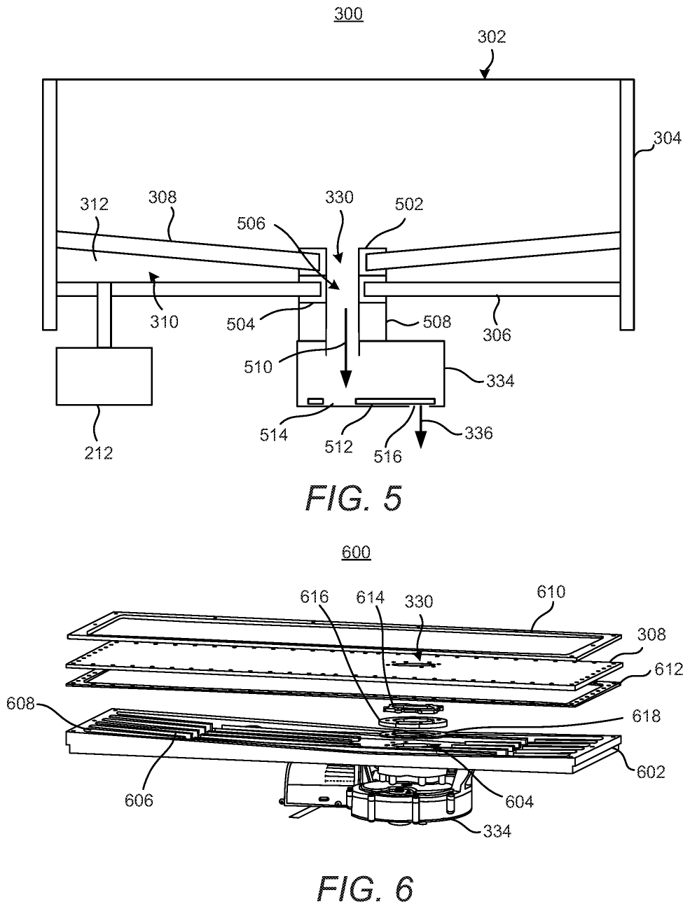

Turning now to FIG. 5, there is shown a schematic diagram of the apparatus 300 depicted in FIG. 3 according to another example. The apparatus 300 is depicted in FIG. 5 as including a hopper 302, side walls 304, a bed 306, a porous membrane 308, a space 310 between the bed 306 and the porous membrane 308, and a drain opening 330 in the porous membrane 308. However, in FIG. 5, the porous membrane 308 is depicted as being sloped from the drain opening 330 to a periphery of the porous membrane 308. In this regard, for instance, the peripheral sections of the porous membrane 308 that may be attached to the side walls 304 may be elevated as compared with the drain opening 330. Particulate material 316 contained in the hopper 302 may thus gravitate more readily toward the drain opening 330 as the particulate material 316 is fluidized as discussed above.

Also shown in FIG. 5 is the gas supply mechanism 212 discussed herein. The gas supply mechanism 212 may supply gas 312 into the space 310 as also discussed herein. The gas 312 may be air or another type of gas that may be supplied to condition the particulate material 316. For instance, the gas 312 may be an inert gas, such as nitrogen, which may reduce or prevent oxidation of the particulate material 316 as compared with oxygen. In some examples, the gas supply mechanism 212 may include a temperature manipulating device to vary the temperature of the gas 312 supplied into the space 310. In this regard, the gas supply mechanism 212 may be a heater, a chiller, or a combination thereof. In addition or in other examples, the gas supply mechanism 212 may include a moisture controlling device to vary the moisture content of the gas 312. The gas supply mechanism 212 may be a humidifier, a dehumidifier, or a combination thereof.

The apparatus 300 may also include a drain member including a first gasket 502 provided in the drain opening 330 of the porous membrane 308 and a second gasket 504 provided in a drain aperture 506 of the bed 306. The first gasket 502 and the second gasket 504 may include respective mating elements (not shown) to connect the first gasket 502 and the second gasket 504 to each other. Thus, for instance, the connection between the first gasket 502 and the second gasket 504 may maintain the porous member 308 in the sloped (or equivalently, angled) arrangement shown in FIG. 5.

As shown, the drain opening 330 and the drain aperture 506 may be aligned with each other such that the particulate material 316 that flows into the drain opening 330 also flows through the drain aperture 506. The particulate material 316 may also flow through a collar 508 that may include an opening that may be aligned with the drain opening 330 and the drain aperture 506. The collar 508 may be attached to the second gasket 504 and in some examples, may be integrated with the second gasket 506. The collar 508 may also be attached to the controllable feeder 334 and in some examples, may be integrated with the controllable feeder 334. In any regard, particulate material 316 may flow through the collar 508 and into the controllable feeder 334 as indicated by the arrow 510.

The controllable feeder 334 may include a rotating member 512 that includes an opening 514 into which the particulate material 316 may flow. In operation, the rotating member 512 may be driven by a motor (not shown) and may rotate about a central axis and as the opening 514 becomes aligned with an outlet opening 516 in the controllable feeder 334, the particulate material 316 in the opening 514 may fall through the outlet opening 516 as indicated by the arrow 336. For instance, the particulate material 316 that is expelled through the outlet opening 516 may be supplied into a conduit (not shown) through which the particulate material 316 may be delivered for usage in the printing of 3D objects and/or in another location of a 3D printer for storage of the particulate material 316 in the other location. According to examples, the rate at which the particulate material 316 is expelled from the hopper 302 may be varied by varying the speed at which the rotating member 512 rotates.

Turning now to FIG. 6, there is shown a perspective, exploded view of an example conditioning assembly 600. The conditioning assembly 600 depicted in FIG. 6 includes the porous membrane 308 discussed above, which may include the drain opening 330. The conditioning assembly 600 may also include a bed 602 that may differ from the bed 306 discussed above with respect to FIGS. 3-5. That is, the bed 602 in the conditioning assembly 600 may include a curved, sloped, concave, or the like, configuration. Particularly, the bed 602 may include a drain aperture 604 and the section, e.g., the upwardly facing surface, of the bed 602 may be curved such that the peripheral areas of the bed 602 are elevated in comparison with the drain aperture 604. In addition, the bed 602 may be formed to include a plurality of dividers 606 to create pockets of spaces 608 in the bed 602 into which pressurized gas 312 may be delivered. The pockets of spaces 608 may be in fluidic connection with the gas supply mechanism 212 via a gas injection opening (not shown) such that the gas supply mechanism 212 may pressurize the spaces 608 with a gas 312 for permeation of the gas through the porous membrane 308. In this regard, the bed 602 may include one or a plurality of connections through which gas may be delivered into the spaces 608.

The conditioning assembly 600 may also include a hold down member 610 and a seal gasket 612. The hold down member 610 may be curved in similar fashion to the bed 602. Although not shown, mechanical fasteners may be provided through the hold down member 610, the porous membrane 308, and the seal gasket 612 and may be fastened to the bed 602. In addition, the conditioning assembly 600 may include a first inner gasket 614, an inner donut 616, and a second inner gasket 618, all of which may be implemented to hold the section of the porous membrane 308 at which the drain opening 330 is located near the drain aperture 604 in the bed 602. In addition, the first inner gasket 614, the inner donut 616, and the second inner gasket 618 may each include aligned holes through which particulate material 316 may flow. In this regard, the porous membrane 308 may have a curved or sloped configuration that may be similar to the curvature of the bed 602. In other examples, the first inner gasket 614, the inner donut 616, and the second inner gasket 618 may be formed as an integrated component.

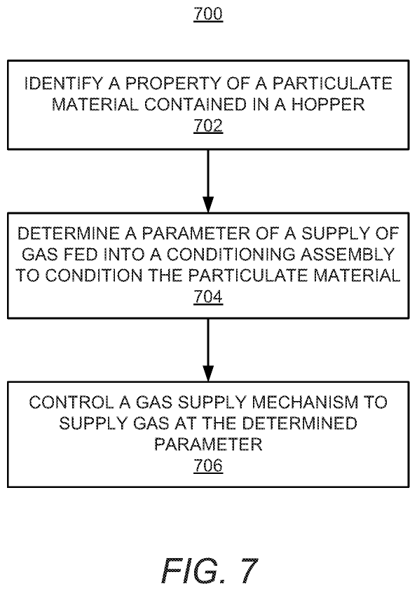

With reference now to FIG. 7, there is shown a flow diagram of an example method 700 for controlling a gas supply mechanism 212 to supply gas at a determined parameter into a conditioning assembly 206. It should be understood that the method 700 may include additional operations and that some of the operations described herein with respect to the method 700 may be omitted or modified without departing from a scope of the method 700. In addition, although the controller 102 shown in FIGS. 1 and 2 is described as implementing the method 700, it should be understood that another controller may implement the method 700 without departing from a scope of the method 700.

At block 702, the controller 102 may identify a property of a particulate material 202, 316 contained in a hopper 204, 302. The property of the particulate material 202 may include a type of the particulate material 202, 316, an amount of the particulate material 202, 316 contained in the hopper 204, 302, or the like. That is, for instance, the controller 102 may receive information pertaining to the property of the particulate material 202, 316 from an input device 210 as discussed above. The controller 102 may thus identify the property of the particulate material 202, 316 from the information received from the input device 210.

At block 704, the controller 102 may determine a parameter of a supply of gas 312 fed into the conditioning assembly 206 based upon the identified property of the particulate material 202, 316. The parameter of the supply of the gas 312 may include the volume flow rate at which the gas 312 is supplied, the temperature of the supplied gas 312, the moisture content of the supplied gas 312, the type of the supplied gas 312, combinations thereof, or the like. As discussed herein, the controller 102 may determine the parameter of the supply of the gas 312 to condition the particulate material 202, 316 responsive to the identified property of the particulate material 202, 316. That is, for instance, as the amount and level of the particulate material 202 increases as additional particulate material 202, 316 is supplied into the hopper 204, the flow of the gas 312 through the porous membrane 308 may not be sufficient to fluidize the particulate material 202, 316. The controller 102 may thus determine that the volume flow rate of the gas 312 supplied into the space 310 may be increased to sufficiently fluidize the additional particulate material 202, 316. Various other examples regarding the determination of the parameter of the supply of gas 312 are discussed elsewhere herein.

At block 706, the controller 102 may control a gas supply mechanism 212 to supply gas 312 at the parameter determined at block 704. For instance, the controller 102 may send an instruction signal to the gas supply mechanism 212 to supply the gas 312 to the conditioning assembly 206 according to the determined parameter. In this regard, the particulate material 202 contained in the hopper 204, 302 may be conditioned in a preselected manner. By way of example, the controller 102 may employ a proportional-integral-derivative (PID) control method to control the gas supply mechanism 212.

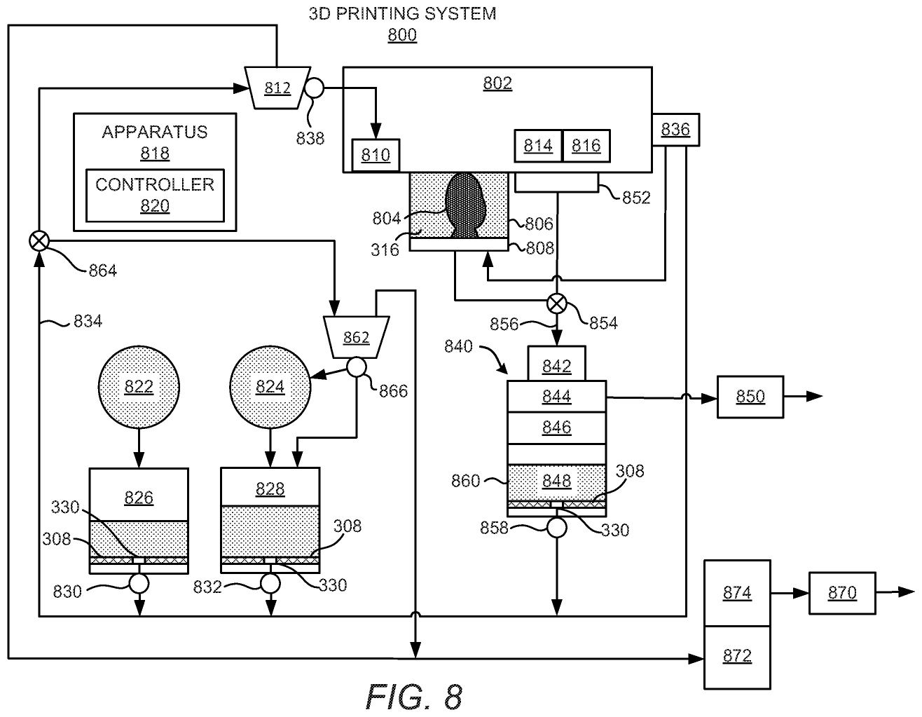

With reference now to FIG. 8, there is shown a block diagram of an example 3D printing system 800 in which the apparatuses 300 and conditioning assemblies 206, 600 disclosed herein may be implemented. It should be understood that the 3D printing system 800 depicted in FIG. 8 may include additional components and that some of the components described herein may be removed and/or modified without departing from a scope of the 3D printing system 800 disclosed herein. The description of FIG. 8 is made with reference to the elements shown in FIGS. 1-6 for purposes of illustration and not of limitation.

As shown, the 3D printing system 800 may include a build chamber 802 within which a 3D object 804 may be fabricated from particulate material 316, e.g., build material particles, provided in respective layers in a build bucket 806. Particularly, a movable build platform 808 may be provided in the build bucket 806 and may be moved downward as the 3D object 804 is formed in successive layers of the particulate material 316. An upper hopper 812, which may include a cyclone separator, may supply a spreader 810 with the particulate material 316. The spreader 810 may move across the build bucket 806 to form the successive layers of the particulate material 316 received from the upper hopper 812.

Forming components 814 may be implemented to deliver an agent onto selected locations on the layers of particulate material 316 to form sections of the 3D object 804 in the successive layers. The forming components 814 may include an agent delivery device or multiple agent delivery devices, e.g., printheads, fluid delivery devices, etc. Thus, although the forming components 814 have been depicted as a single element, it should be understood that the forming components 814 may represent multiple elements. A heating mechanism 816 to apply heat onto the layers of particulate material 316 to form the sections of the 3D object 804 may also be provided in the build chamber 802.

According to examples, the agent may be a fusing agent that may enhance absorption of heat from the heating mechanism 816 to heat the particulate material 316 to a temperature that is sufficient to cause the particulate material 316 upon which the agent has been deposited to melt. In addition, the heating mechanism 816 may apply heat, e.g., in the form of heat and/or light, at a level that causes the particulate material 316 upon which the agent has been applied to melt without causing the particulate material 316 upon which the agent has not been applied to melt. In other examples, the agent may be a chemical binder that may cause the particulate material 316 upon which the agent is deposited to bind together to form part of a 3D object when the agent solidifies. In these examples, the heating mechanism 816 may be implemented to dry the agent or may be omitted in instances in which the chemical binder binds the particulate material 316 in the absence of additional heat.

The forming components 814 may supply multiple types of agents onto the layers of particulate material 316. The multiple types of agents may include agents having different properties with respect to each other. In this regard, a controller 820 of a computing apparatus 818 may control the forming components 814 to supply the agent or a combination of agents that results in the object 804 having certain features. By way of particular example, the multiple types of agents may be differently colored inks and the controller 820 may control the forming components 814 to deposit an agent or a combination of agents onto particulate material 316 to form an object 804 having a particular color from the particulate material 316.

The controller 820 may control various operations in the 3D printing system 800 including the spreader 810, the hopper 812, and the forming components 814. The controller 820 may implement operations to control the forming components 814 to form the 3D object 804 in a volume of particulate material 316 contained in the build bucket 806. The controller 820 may also be equivalent to the controller 102 discussed above and the computing apparatus 818 may be equivalent to the computing apparatus 100 discussed above.

The particulate material 316 used to form the 3D object 804 may be composed of particulate material from a fresh supply 822 of build material particles, build material particles from a recycled supply 824 of build material particles, or a mixture thereof. The fresh supply 822 may represent a removable container that contains particulate material 316 that has not undergone any 3D object formation cycles. The recycled supply 824 may represent a removable container that contains particulate material 316 that has undergone at least one 3D object formation cycle and may contain particles that have undergone different numbers of 3D object formation cycles with respect to each other.

As shown, the particulate material 316 in the fresh supply 822 may be provided into a fresh material hopper 826 and the particulate material 316 in the recycled supply 824 may be provided into a recycled material hopper 828. Additionally, the particulate material 316 in either or both of the fresh material hopper 826 and the recycled material hopper 828 may be supplied to the upper hopper 812. The particulate material 316 may be provided into the hoppers 826, 828 from the respective supplies 822, 824 prior to implementing a print job to ensure that there are sufficient particulate materials 316 to complete the print job. Either or both of the hoppers 826, 828 may be equivalent to the apparatuses 300 discussed herein. Thus, for instance, the hoppers 826 and/or 828 may include a conditioning assembly 206, e.g., a porous membrane 308 having a drain opening 330, to fluidize particulate material 316 contained in the hoppers 826 and/or 828.

Generally speaking, the controller 820 may control the mixture or ratio of the fresh particles and recycled particles that are supplied to the upper hopper 812. The ratio may depend upon the type of 3D object 804 being formed. For instance, a higher fresh particle to recycled particle ratio, e.g., up to a 100 percent fresh particle composition, may be supplied when the 3D object 804 is to have a higher quality, to have thinner sections, have higher tolerance requirements, or the like. Conversely, a lower fresh particle to recycled particle ratio, e.g., up to a 100 percent recycled particle composition, may be supplied when the 3D object 804 is to have a lower quality as may occur when the 3D object 804 is a test piece or a non-production piece, when the 3D object 804 is to have lower tolerance requirements, or the like. The ratio may be user-defined, may be based upon a particular print job, may be based upon a print setting of the 3D printing system 800, and/or the like.

In any regard, the controller 820 may control the ratio of the fresh and the recycled particles supplied to the upper hopper 812 through control of respective feeders 830, 832. The feeders 830, 832 may be equivalent to the controllable feeders 334 discussed herein with respect to FIGS. 3-6. A first feeder 830 may be positioned to supply particulate material 316 to a supply line 834 from the fresh material hopper 826 and the second feeder 832 may be positioned to supply particulate material 316 to the supply line 834 from the recycled material hopper 828. The first feeder 830 and the second feeder 832 may be rotary airlocks that may regulate the flow of the particulate material 316 from the respective hoppers 826, 828 to the feed line 834 for delivery to the upper hopper 812. The feed line 834 may also be supplied with air from an input device 836 to assist in the flow of the particulate materials 316 from the hoppers 826, 828 to the upper hopper 812.

A third feeder 838, which may also be a rotary airlock (which allows forward-flow of powder and restricts back-flow of air), may be positioned along a supply line from the upper hopper 812 to the spreader 810. The upper hopper 812 may include a level sensor (not shown) that may detect the level of particulate material 316 contained in the upper hopper 812. The controller 820 may determine the level of the particulate material 316 contained in the upper hopper 812 from the detected level and may control the feeders 830, 832 to supply additional particulate material 316 in a particular ratio when the controller 820 determines that the particulate material 316 level in the upper hopper 812 is below a threshold level, e.g., to ensure that there is a sufficient amount of particulate material 316 to form a layer of particulate material 316 having a certain thickness during a next spreader 810 pass.

The 3D printing system 800 may also include a collection mechanism 840, which may include a blow box 842, a filter 844, a sieve 846, and a reclaimed material hopper 848. The reclaimed material hopper 848 may be equivalent to the apparatuses 300 discussed herein. Thus, for instance, the reclaimed hopper 848 may include a conditioning assembly 206 to condition particulate material 316, e.g., a porous membrane 308 having a drain opening 330, contained in the reclaimed hopper 848. The reclaimed hopper 848 may also include gas supply mechanism 212 to supply gas into the conditioning assembly 206. In addition, airflow through the collection mechanism 840 may be provided by a collection blower 850. The collection mechanism 840 may reclaim incidental particulate material 316 from the build bucket 806 as well as from a location adjacent to the build bucket 806 as shown in FIG. 8. Particularly, following formation of the 3D object 804, the particulate material 316 may remain in powder form and the collection mechanism 840 may reclaim the particulate material 316 that was not formed into the 3D object 804. That is, the incidental particulate material 316 may be separated from the 3D object 804 through application of a vacuum force inside the build bucket 806. The collection mechanism 840 may also be vibrated to separate the incidental particulate material 316 from the 3D object 804.

The incidental particulate material 316 in the build bucket 806 may be sucked into the blow box 842 and through the filter 844 and the sieve 846 before being collected in the reclaimed material hopper 848. Additionally, during spreading of the particulate material 316 to form layers on the build bucket 806, e.g., as the spreader 810 moves across the build bucket 806, excess particulate material 316 may collect around a perimeter of the build bucket 806. As shown, a perimeter vacuum 852 may be provided to collect the excess particulate material 316, such that the collected particulate material 316 may be supplied to the collection mechanism 840. A valve 854, such as an electronically controllable three-way valve, may be provided along a feed line 856 from the build bucket 806 and the perimeter vacuum 852. In examples, the controller 820 may manipulate the valve 854 such that particles flow from the perimeter vacuum 852 during formation of the 3D object 804 and flow from the build bucket 806 following formation of the 3D object 804.

A fourth feeder 858, which may also be a rotary airlock, may be provided to feed the reclaimed particulate material 860 contained in the reclaimed material hopper 848 to the upper hopper 812 and/or to a lower hopper 862. The fourth feeder 858 may feed the reclaimed particulate material 860 through the feed line 834. A valve 864, such as an electronic three-way valve, e.g., the valve 864 may be a three-port, two-state valve in which materials may flow in one of two directions), may be provided along the feed line 834 and may direct the reclaimed particulate material 860 to the upper hopper 812 or may divert the reclaimed particulate material 860 to the lower hopper 862. The controller 820 may also manipulate the valve 864 to control whether the reclaimed particulate material 860 are supplied to the upper hopper 812 or the lower hopper 862. As discussed above, the controller 820 may make this determination based upon the ratio of fresh and recycled particulate materials that is to be used to form the 3D object 804.

A fifth feeder 866, which may also be a rotary airlock, may be provided to feed the reclaimed particulate material 316 contained in the lower hopper 862 to the recycled supply 824 and/or the recycled material hopper 828. The controller 820 may control the fifth feeder 866 to feed the reclaimed particulate material 860 into the recycled supply 824 in instances in which the reclaimed particulate material 860 are not to be used in a current build. In addition, the controller 820 may control the fifth feeder 866 to feed the reclaimed particulate material 860 into the recycled material hopper 828 in instances in which the reclaimed particulate material 860 are to be used in a current or a next build.

The 3D printing system 800 may also include a blower 870 that may create suction to enhance airflow through the lines in the 3D printing system 800. The airflow may flow to a filter box 872 and a filter 874 that may remove particulates from the airflow from the upper hopper 812 and the lower hopper 862 prior to the airflow being exhausted from the 3D printing system 800. In other words, the blower 870, filter box 872, and filter 874 may represent parts of the outlets of the upper hopper 812 and the lower hopper 862 and may collect particulates that were not removed from the airflow in cyclone separators connected to the upper and/or lower hoppers 812 and 862.

Although not shown in FIG. 8, the computing apparatus 818 may also include an interface through which the controller 820 may communicate instructions to a plurality of components contained in the 3D printing system 800. The interface may be any suitable hardware and/or software through which the controller 820 may communicate the instructions. In any regard, the controller 820 may communicate with the components of the 3D printing system 800 as discussed above.

The controller 820 may be a semiconductor-based microprocessor, a central processing unit (CPU), an application specific integrated circuit (ASIC), a field-programmable gate array (FPGA), a graphics processing unit (GPU), a tensor processing unit (TPU), and/or other hardware device. The computing apparatus 818 may also include a memory that may have stored thereon machine readable instructions (which may also be termed computer readable instructions) that the controller 820 may execute. The memory may be an electronic, magnetic, optical, or other physical storage device that contains or stores executable instructions. The memory may be, for example, Random Access memory (RAM), an Electrically Erasable Programmable Read-Only Memory (EEPROM), a storage device, an optical disc, and the like. The memory, which may also be referred to as a computer readable storage medium, may be a non-transitory machine-readable storage medium, where the term “non-transitory” does not encompass transitory propagating signals.

Although described specifically throughout the entirety of the instant disclosure, representative examples of the present disclosure have utility over a wide range of applications, and the above discussion is not intended and should not be construed to be limiting, but is offered as an illustrative discussion of aspects of the disclosure.

What has been described and illustrated herein is an example of the disclosure along with some of its variations. The terms, descriptions and figures used herein are set forth by way of illustration only and are not meant as limitations. Many variations are possible within the spirit and scope of the disclosure, which is intended to be defined by the following claims—and their equivalents—in which all terms are meant in their broadest reasonable sense unless otherwise indicated.

What is claimed is:

1. An apparatus comprising:
a controller to:
identify a property of particulate material contained in a container;
determine, based upon the identified property of the particulate material, a parameter of a supply of gas fed into a conditioning assembly to condition the particulate material contained in the container; and
control a mechanism to supply the gas at the determined parameter into the conditioning assembly.

2. The apparatus according to claim 1, wherein the controller is further to identify a level of the particulate material in the container and wherein the property of the particulate material is the level of the particulate material in the container.

3. The apparatus according to claim 2, wherein the controller is further to:
receive an indication of a detected weight of the container; and
identify the level of the particulate material from the detected weight of the container.

4. The apparatus according to claim 2, wherein the conditioning assembly comprises a bed, a porous membrane, and a space between the bed and the porous membrane, and wherein the controller is further to:
receive an indication of a detected pressure level inside the space; and
identify the level of the particulate material from the detected pressure level.

5. The apparatus according to claim 1, wherein the identified property of the particulate material is a type of the particulate material.

6. The apparatus according to claim 5, wherein the instructions are further to cause the processor to:
access information pertaining to the particulate material stored on a chip corresponding to the particulate material; and
identify the type of the particulate material from the accessed information.

7. The apparatus according to claim 1, wherein the instructions are further to cause the processor to:
access a database that includes data correlating a plurality of particulate material properties and gas supply parameters; and
determine the parameter of the supply of gas from the accessed database.

8. The apparatus according to claim 1, wherein the parameter comprises gas type, gas supply velocity, gas supply volume flow rate, gas temperature, gas supply moisture content, or combinations thereof.

9. A method comprising:
identifying a property of build material particles provided in a hopper;
determining, based on the identified property of the build material particles, a parameter of a supply of gas fed into the build material particles provided in the hopper, wherein the parameter of the supply of gas is to condition the build material particles to a certain level; and
controlling a mechanism to supply the gas at the determined parameter into a conditioning assembly to condition the build material particles, wherein the gas is supplied into the build material particles contained in the hopper via the conditioning assembly.

10. The method according to claim 9, wherein the property of the build material particles comprises at least one of an amount of build material particles contained in the container or a type of the build material particles contained in the container.

11. The method according to claim 9, wherein the parameter comprises at least one of gas type, gas supply velocity, gas supply volume flow rate, gas supply temperature, or gas supply humidity and wherein controlling the mechanism further comprises controlling the mechanism to vary at least one of gas type, gas supply velocity, gas supply volume flow rate, gas supply temperature, gas supply humidity, or combinations thereof.

12. The method according to claim 9, wherein controlling the mechanism further comprises controlling the mechanism to supply the gas into the conditioning assembly, the conditioning assembly having a bed and a porous membrane, wherein the build material particles are supported on the porous membrane.

13. A system comprising:
a conditioning assembly having a bed and a porous membrane, wherein the conditioning assembly is to condition particulate material supported on the porous membrane;
a mechanism to control a supply of gas into a space between the bed and the porous membrane, wherein the gas is to permeate through channels in the porous membrane and into the particulate material to condition the particulate material, wherein the channels follow a tortuous path through the porous membrane;
a controller to,
identify a property of the particulate material supported on the porous membrane;
determine, based upon the identified property of the particulate material, a parameter of the supply of the gas to condition the particulate material to a certain level; and
control the mechanism to supply the gas into the space according to the determined parameter.

14. The system according to claim 13, wherein the property of the particulate material comprises at least one of an amount of particulate material contained in the container or a type of the particulate material contained in the container.

15. The system according to claim 13, wherein the parameter comprises at least one of gas type, velocity of gas supply, volume flow rate of gas supply, temperature of the gas supply, moisture content of the gas supply, or combinations thereof.
